(19) United States
(12) Patent Application Publication
(10) Pub. No.: US 2013/0311218 A1
(43) Pub. Date: Nov. 21, 2013

(54) FARMING SUPPORT METHOD AND FARMING SUPPORT APPARATUS

(71) Applicant: FUJITSU LIMITED, Kawasaki-shi (JP)

(72) Inventors: Jun MAEDA, Chofu (JP); Yoshinori YAGINUMA, Kokubunji (JP)

(73) Assignee: FUJITSU LIMITED, Kawasaki-shi (JP)

(21) Appl. No.: 13/949,282

(22) Filed: Jul. 24, 2013

Related U.S. Application Data
(63) Continuation of application No. PCT/JP2011/063385, filed on Jun. 10, 2011.

(30) Foreign Application Priority Data
Jan. 25, 2011 (JP) 2011-012564

(51) Int. Cl. G06Q 10/06

(52) U.S. Cl. CPC G06Q 10/063
USPC 705/7.11

(57) ABSTRACT

A farming support method includes accepting input of information indicating a state of a crop or information indicating a state of an environment, and extracting, from a first storage unit that stores restriction information including a condition related to the state of the crop or the state of the environment and a work instruction for a case in which the condition is satisfied, the restriction information having the condition matching the information indicating the state of the crop or the information indicating the state of the environment that is input. The method further includes judging, using a second storage unit that stores a judgement result on whether to adopt each restriction information for each cultivation example of the crop, whether to adopt the restriction information that is extracted.

### CROSS-REFERENCE TO RELATED APPLICATIONS

This application is a continuation application of International Application No. PCT/JP2011/063385 filed on Jun. 10, 2011 and designated the U.S., which is based upon and claims the benefit of priority of the prior Japanese Patent Application No. 2011-012564 filed on Jan. 25, 2011, the entire contents of which are incorporated herein by reference.

### FIELD

The embodiments discussed herein are related to a farming support method, a farming support apparatus, and a computer-readable storage medium.

### BACKGROUND

In farming or agriculture, in order to produce a crop with a quality and an amount as planned according to expectations, knowledge and know-how peculiar to the land related to cultivating the crop are important. Recently, there is a proposal to develop a computer system to support farming for cultivating the crop, by computerizing the knowledge and the know-how, so that the knowledge and the know-how may be inherited from one person to another.

The applicant is aware of Japanese Laid-Open Patent Publication No. 2001-34625.

An example of the computerizing may represent information related to past experiences of a farmer and farming instructions acquired from an expert, document, and the like according to a rule, and register the information in the computer system. The rule in this case refers to information indicating the work (or work instruction) to be performed in correspondence with the crop, the environment, or the like. The computer system may output the work instruction based on the rule, according to changes in the state of the crop, the environment, or the like.

However, even when cultivating the same crop, there are various cultivation policies, values, and the like. For this reason, the work instruction that is uniformly output according to the rule may not necessarily be appropriate for the cultivation policy, value, or the like of each worker or farmer.

### SUMMARY

Accordingly, it is an object in one aspect of the embodiment to provide a farming support method, a farming support apparatus, and a computer-readable storage medium, which may support a judgement on whether to adopt a rule related to a work instruction of farming.

According to one aspect of the present invention, a farming support method including accepting, by a processor, input of information indicating a state of a crop or information indicating a state of an environment; extracting, by the processor, from a restriction information storage unit that stores restriction information including a condition related to the state of the crop or the state of the environment and a work instruction for a case in which the condition is satisfied, the restriction information having the condition matching the information indicating the state of the crop or the information indicating the state of the environment that is input; and judging, by the processor, using an adoption log storage unit that stores a judgement result on whether to adopt each restriction information for each cultivation example of the crop, whether to adopt the restriction information that is extracted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a farming support system in a first embodiment;

FIG. 2 is a diagram illustrating an example of a hardware configuration of a farming support apparatus in one embodiment of the present invention;

FIG. 3 is a diagram for explaining an example of a process of the farming support apparatus in the first embodiment;

FIG. 4 is a flow chart for explaining an example of processing procedures of a work rule adoption judging process of the farming support apparatus in the first embodiment;

FIG. 5 is a diagram illustrating an example of event data;

FIG. 6 is a diagram illustrating an example of a configuration of a state data storage unit;

FIG. 7 is a diagram illustrating an example of state updating rules;

FIG. 8 is a diagram illustrating examples of work rules;

FIG. 9 is a diagram illustrating another example of the functional configuration of the farming support system in the first embodiment;

FIG. 10 is a diagram for explaining an example of the process of the farming support apparatus in a second embodiment;

FIG. 11 is a diagram for explaining an example of the process of the farming support apparatus in a third embodiment;

FIG. 12 is a diagram illustrating an example of a configuration of a cultivation attribute storage unit;

FIG. 13 is a diagram illustrating an example of a functional configuration of the farming support system in a fourth embodiment;

FIG. 14 is a diagram for explaining an example of the process of the farming support apparatus in the fourth embodiment;

FIG. 15 is a flow chart for explaining an example of processing procedures of a validity evaluating process on a work rule adoption result;

FIG. 16 is a diagram illustrating an example of a configuration of a work rule adoption log storage unit in the fourth embodiment;

FIG. 17 is a diagram illustrating an example of a functional configuration of the farming support system in a fifth embodiment;

FIG. 18 is a diagram for explaining an example of the process of the farming support apparatus in the fifth embodiment;

FIG. 19 is a flow chart for explaining an example of processing procedures of a model cultivating example registration process; and

FIG. 20 is a flow chart for explaining an example of processing procedures of the work rule adoption judging process of the farming support apparatus in the fifth embodiment.

### DESCRIPTION OF EMBODIMENTS

Preferred embodiments of the present invention will be described with reference to the accompanying drawings.

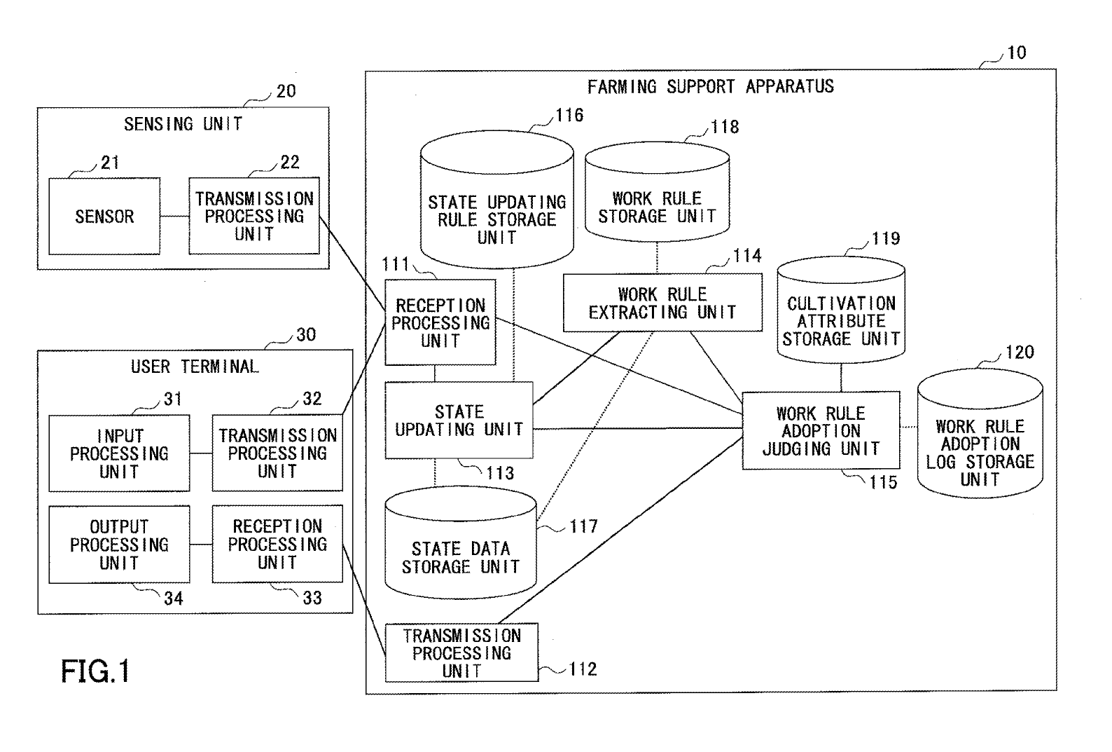

A description will now be given of the farming support method and the farming support apparatus in each embodiment according to the present invention. FIG. 1 is a diagram illustrating an example of a functional configuration of the farming support system in a first embodiment. In FIG. 1, a sensing unit 20, a user terminal 30, and a farming support apparatus 10 may be communicably connected via a network, such as a LAN (Local Area Network) or the Internet, for example. The network may be a cable network, a wireless network, or a combination of cable and wireless networks. The sensing unit 20, the user terminal 30, and the farming support apparatus 10 do not necessarily have to be distributed, and the sensing unit 20, the user terminal 30, and the farming support apparatus 10 may be formed by a single computer.

The sensing unit 20 may include a sensor 21 and a transmission processing unit 22. The sensor 21 may sense or measure data (hereinafter also referred to as “environment information”) indicating the temperature, humidity, sunshine, wind velocity, soil temperature, soil moisture, and the like of the farm. The transmission processing unit 22 may transmit the environment information measured by the sensor 21 to the farming support apparatus 10. The environment information may be transmitted in real-time, or may be transmitted periodically. When periodically transmitting the environment information, the environment information accumulated in the sensing unit 20 during a predetermined period may be transmitted in a batch transmission. In addition, the environment information measured by the sensing unit 20 may be transferred to the farming support apparatus 10 via the user terminal 30.

The user terminal 30 may be formed by an information processing apparatus, such as a PC (Personal Computer), PDA (Personal Digital Assistant), mobile phone, smart phone, and the like, that functions as a user interface of the farming support system. The user terminal 30 may include an input processing unit 31, a transmission processing unit 32, a reception processing unit 33, and an output processing unit 34. A program installed in the user terminal 30 may cause a CPU (Central Processing Unit) of the user terminal 30 to execute processes of the input processing unit 31, the transmission processing unit 32, the reception processing unit 33, and the output processing unit 34.

The input processing unit 31 may accept input of observation information, work information, and the like of the farm. The observation information may refer to information indicating a state of the crop (or growing state, hereinafter also referred to as “crop state”), disease and pest generation, weed generation, crop dry state, and the like. The work information may refer to information indicating work contents (for example, seeding, setting, cultivating, plowing, pesticide application, fertilizer application, harvesting, etc.) of a worker, for example. The transmission processing unit 32 may transmit the observation information or the work information accepted by the input processing unit 31 to the farming support apparatus 10. The reception processing unit 33 may receive a processed result and the like from the farming support apparatus 10. The output processing unit 34 may output the processed result and the like, by displaying the processed result and the like, for example.

The farming support apparatus 10 may include a reception processing unit 111, a transmission processing unit 112, a state updating unit 113, a work rule extracting unit 114, a work rule adoption judging unit 115, a state updating rule storage unit 116, a state data storage unit 117, a work rule storage unit 118, a cultivation attribute storage unit 119, and a work rule adoption log storage unit 120.

The reception processing unit 111 may receive the environment information transferred from the sensing unit 20, and the observation information and the work information transferred from the user terminal 30.

The state data storage unit 117 may store state data. The state data may refer to data indicating the state of the environment (hereinafter also referred to as “environment state”), the crop state, or the like of the farm. The state data may be recorded for each cropping, for example. One cropping refers to a unit of time from a start of cropping of one crop until harvesting the one crop.

The state updating rule storage unit 116 may store state updating rule groups. The state updating rule may refer to data in which updating contents of the state data are defined according to the environment state, crop state, or the like of the farm. More particularly, the state updating rule may include a condition part (IF statement) and a consequence part (THEN statement). Conditions of the environment state, the crop state, or the like of the farm may be defined in the condition part. In a case in which the conditions defined in the condition part are satisfied, the updating contents to be applied to the state data may be defined in the consequence part. The state updating rule may be defined separately for each kind of crop. For example, the state updating rule storage unit 116 may be provided for each kind of crop. Of course, a common state updating rule may be defined with respect to a plurality of kinds of the crop.

The state updating unit 113 may update the state data in the state data storage unit 117 by applying the state updating rule according to the environment information, the observation information, the work information, and the like received by the reception processing unit 111. Hence, the state data of the state data storage unit 117 may be successively updated according to a change in the environment state, a change in the crop state, or the like of the farm.

The work rule storage unit 118 may store work rule groups. The work rule may refer to data in which the work to be performed is defined according to the environment state, the crop state, or the like of the farm. More particularly, the work rule may include a condition part and a consequence part. Conditions of the environment state, the crop state, or the like of the farm may be defined in the condition part. In a case in which the conditions defined in the condition part are satisfied, the work contents (or work instructions) to be performed may be defined in the consequence part. The work rule may be defined separately for each kind of crop. For example, the work rule storage unit 118 may be provided for each kind of crop. Of course, a common work rule may be defined with respect to a plurality of kinds of the crop.

The work rule extracting unit 114 may extract from the work rule storage unit 118 the work rule having a condition part matching the environment information, the observation information, the work information, or the state data stored in the state data storage unit 117.

The work rule adoption judging unit 115 judges whether to adopt the work rule extracted by the work rule extracting unit 114, using the work rule adoption log storage unit 120 and the cultivation attribute storage unit 119. Judging whether to adopt the work rule may refer to judging whether the work rule is to be adopted (or applied). In addition, judging whether to adopt the work rule may refer to judging whether to follow the work instruction indicated by the work rule. Accordingly, judging whether to adopt the work rule may be equivalent to judging whether to adopt the work instruction indicated by the work rule. In addition, the work rule adoption judging unit 115 may receive, from the user terminal 30 via the reception processing unit 111, for example, information (that is, judgement result on work rule adoption) related to whether a user performed the work, according to the work instruction of the work rule extracted by the work rule extracting unit 114. The work rule adoption judging unit 115 may record the judgement result of the work rule adoption in the work rule adoption log storage unit 120.

The work rule adoption log storage unit 120 may store a log of the judgement result the work rule adoption for each cultivation example of the crop (or for each cultivation). The cultivation attribute storage unit 119 may store attribute information of each cultivation example stored in the work rule adoption log storage unit 120.

The transmission processing unit 112 may transmit the judgement result of the work rule adoption judging unit 115 and the like to the user terminal 30.

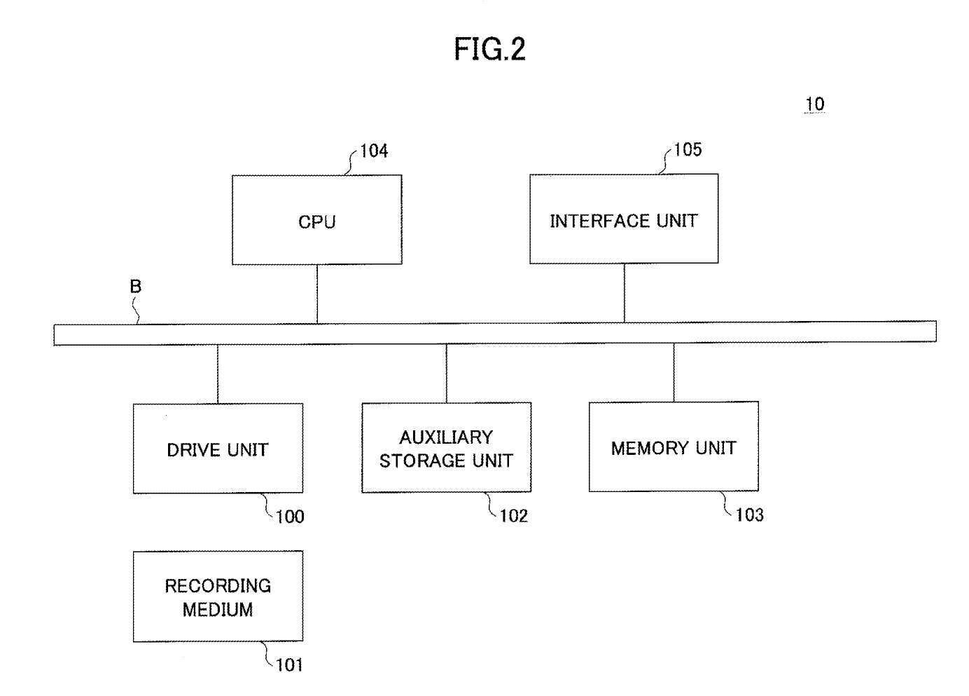

FIG. 2 is a diagram illustrating an example of a hardware configuration of the farming support apparatus in one embodiment of the present invention. The farming support apparatus 10 illustrated in FIG. 2 may include a drive unit 100, an auxiliary storage unit 102, a memory unit 103, a CPU 104, and an interface unit 105 that are mutually connected via a bus B.

The program for causing the CPU 104 to execute processes of the farming support apparatus 10 may be recorded on a recording medium 101. When the recording medium 101 recorded with the program is loaded into the drive unit 100, the program may be installed from the recording medium 101 to the auxiliary storage unit 102 via the drive unit 100. Of course, the program does not necessarily have to be installed from the recording medium 101, and for example, the program may be downloaded from another computer via the network. The auxiliary storage unit 102 may store the installed program other files, data, and the like that may be required.

The memory unit 103 may read the program from the auxiliary storage unit 102 and store the program in the memory unit 103 when a program boot instruction is received. The CPU 104 may execute functions of the farming support apparatus 10 according to the program stored in the memory unit 103. The interface unit 105 may provide an interface for connecting the farming support apparatus 10 to the network.

Examples of the recording medium 101 may include portable recording media such as a CD-ROM (Compact Disk-Read Only Memory), DVD (Digital Versatile Disk), USB (Universal Serial Bus) memory, and the like, for example. In addition, examples of the auxiliary storage unit 102 may include a HDD (Hard Disk Drive), flash memory, and the like. Each of the recording medium 101 and the auxiliary storage unit 102 may form a non-transitory computer-readable storage medium.

A program installed in the farming support apparatus 10 may cause the CPU 104 to execute processes of the reception processing unit 111, the transmission processing unit 112, the state updating unit 113, the work rule extracting unit 114, and the work rule adoption judging unit 115. The state updating rule storage unit 116, the state data storage unit 117, the work rule storage unit 118, the cultivation attribute storage unit 119, and the work rule adoption log storage unit 120 may be formed by the auxiliary storage unit 102 or a storage unit (not illustrated) that is connected to the farming support apparatus 10 via the network.

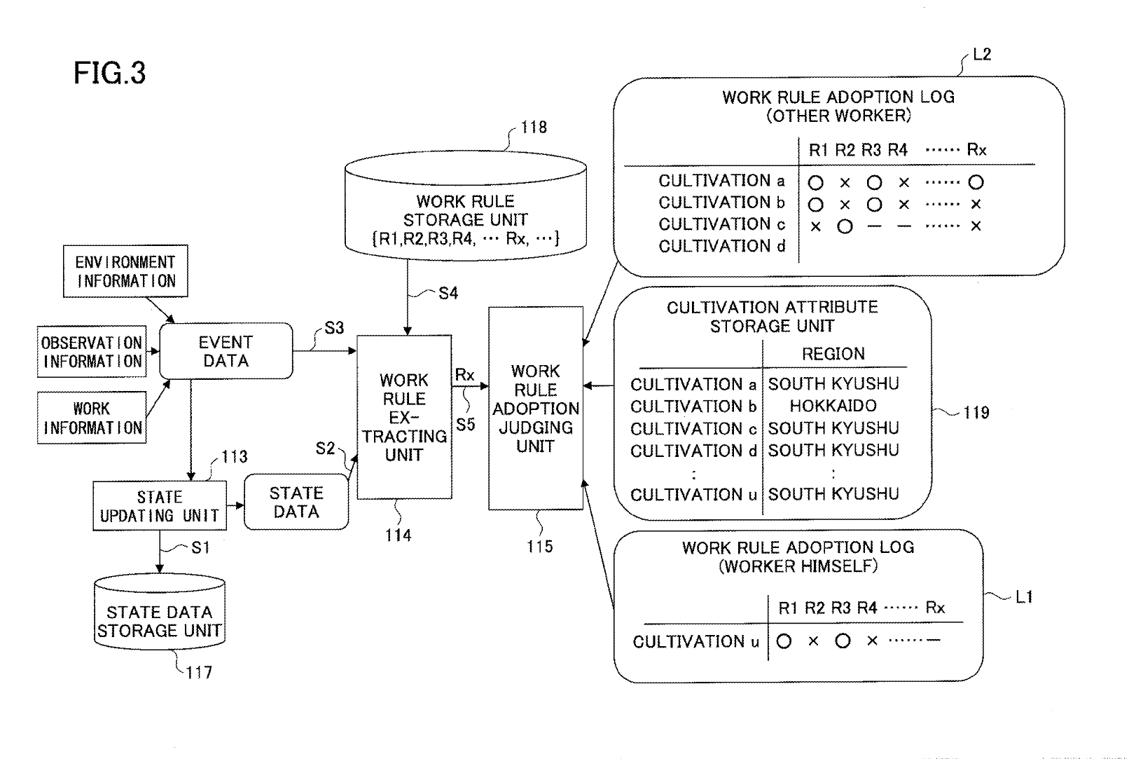

FIG. 3 is a diagram for explaining an example of the process of the farming support apparatus in the first embodiment. In FIG. 3, data such as the environment information, the observation information, the work information, and the like input from outside the farming support apparatus 10 (for example, from the sensing unit 20 or the user terminal 30) are represented as “event data”. The information from the sensing unit 20 or the user terminal 30 may be input at any time or may be input periodically (for example, once a day). In this embodiment, the kind of crop that is a cultivation target may be referred to as “crop U”. In addition, the cultivation (one cropping) that is presently performed with respect to the crop U may be referred to as “cultivation u”.

When the reception processing unit 111 receives the event data, the state updating unit 113 may extract from the state updating rule storage unit 116 the state updating rule whose condition part matches the event data and the state data within the stage updating rules related to the crop U. The state updating unit 113 may update the state data related to the cultivation “u” in the state data storage unit 117 based on the consequence part of the extracted state updating rule (step S1). Next, the state updating unit 113 may input the state data and the event data to the work rule extracting unit 114 (steps S2 and S3).

The work rule extracting unit 114 may extract from the work rule storage unit 118 the work rule related to the crop U and whose condition part matches the event data or the state data (step S4). The work rule extracting unit 114 may input the extracted work rule to the work rule adoption judging unit 115 (step S5). In FIG. 3, R1, R2, R3, R4, . . . , and Rx illustrated within the work rule storage unit 118 indicate the work rules related to the crop U. Step S4 in FIG. 3 illustrates an example in which the work rule Rx is extracted from the work rules stored in the work rule storage unit 118.

The work rule adoption judging unit 115 may collate a work rule adoption log L1 of the user related to the cultivation “u” up to the present, and a work rule adoption log L2 of another worker for the cultivation example of the crop U in the past, and extract the cultivation example of the other worker similar to or matching an adoption pattern of the work rule adoption. In other words, at least the work log adoption log L1 is the work rule adoption log related to the crop U that is presently being cultivated.

The work rule adoption log L1 and the work rule adoption log L2 may be stored in the work rule adoption log storage unit 120. The adoption pattern may refer to a pattern of the adoption result for each work rule, indicated by the adoption log. In FIG. 3, a symbol “o” indicates that the work rule is adopted, a symbol “x” indicates that the work rule is not adopted, and a symbol “-” indicates that the work rule is not extracted, with respect to each of the work rules R1, R2, R3, R4, . . . , and Rx, for each cultivation (one cropping).

The adoption result (“o” or “x”) in the work rule adoption log may indicate a final adoption result based on user judgement. In other words, the adoption result in the work rule adoption log is not an automatic judgement result of the work rule adoption judging unit 115.

In this embodiment, the user may refer to the worker himself who utilizes services of the farming support system. As is clear from the work rule adoption log L1, the user in this embodiment may be identified by as “worker U”. Other workers may refer to workers in farms other than the farm where the user works. The user is not limited to one user, and the other workers are not limited to one worker. Each of the user and the other workers may be a group of a plurality of workers. In addition, a similar adoption pattern may refer to a pattern in which a percentage of matching the judgement result of the work rule adoption is higher than or equal to a predetermined value. Accordingly, when the cultivation example having the adoption pattern similar to or matching the work rule adoption log L1 is extracted, the extracted cultivation example may have a relatively large number of matching adoption results amongst the cultivation examples of the other worker.

The work rule adoption judging unit 115 may refer to the cultivation attribute storage unit 119 and specify the cultivation example of the other worker for the same cultivation “u”. As illustrated in FIG. 3, the cultivation attribute storage unit 119 in the first embodiment may store a region where the farm is located for each cultivation example.

The work rule adoption judging unit 115 may automatically judge whether to adopt the work rule Rx, based on the work rule adoption log L2 of the cultivation example of the other worker similar to or matching the adoption pattern of the work rule adoption for the cultivation “u”, or the cultivation example of the other worker in the farm located in the same region as the cultivation “u”.

For example, with respect to the work rules R1 through R4 illustrated in FIG. 3, other cultivation examples similar to the adoption pattern of the cultivation “u” are “cultivation a” and “cultivation b”. In other words, the work rules R1 and R3 are adopted and the work rules R2 and R4 are not adopted by each of the cultivations “u”, “a”, and “b”. On the other hand, a cultivation example in the farm located in the same region as the cultivation “u” is “cultivation a”. Accordingly, the work rule adoption judging unit 115 may judge to “adopt” the work rule Rx, based on the judgement result on work rule adoption of the work rule Rx related to the cultivation “a”.

In this embodiment, a unit with which the adoption patterns of the work rules are compared is one cropping unit, because the condition and the environment of the crop in the farm may change for each cropping unit, and it may be desirable to take into consideration the fact that the cultivation policy and the like may change with such changes in the condition and the environment of the crop. Further, in the first embodiment, the similarity of the conditions and the environments required for the crop or the similarity of the cultivation policies and the like is evaluated according to the similarity of the adoption patterns of the work rule adoption, identity of the region where the farm is located, and the like.

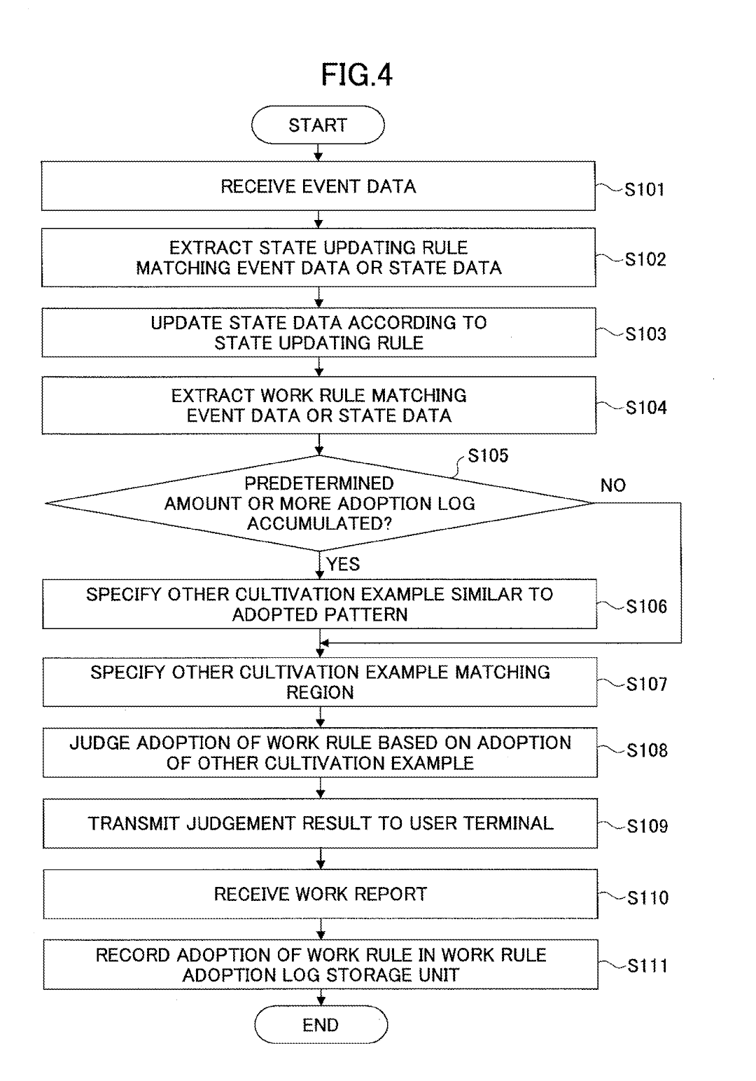

Next, a description will be given of processing procedures of the general process described in FIG. 3. FIG. 4 is a flow chart for explaining an example of the processing procedures of a work rule adoption judging process of the farming support apparatus in the first embodiment. For example, a user identifier (worker ID), a cultivation example identifier (cultivation ID), and a kind of crop (crop U) that is a cultivation target may be specified in the farm support apparatus 10 by a user log-in process or the like with respect to the farm support apparatus 10. The cultivation ID may be used as a key to specify the user and the kind of crop. For example, a storage unit may be provided to store the worker name, the kind of crop, and the like for each cultivation ID.

In step S101, the reception processing unit 111 may receive the event data from the sensing unit 20 or the user terminal 30. The reception of the event data may be non-periodic or periodic.

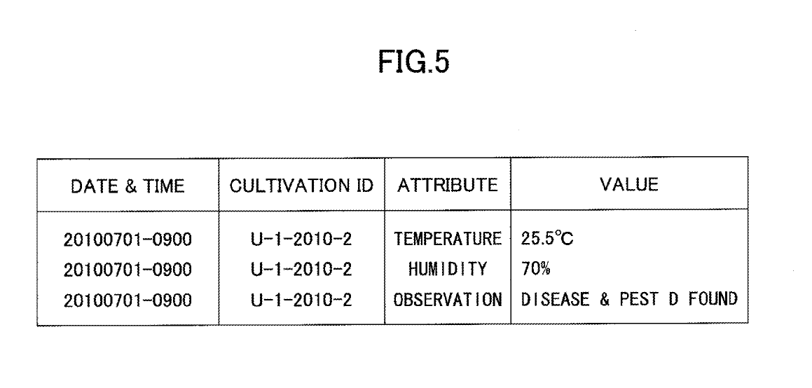

FIG. 5 is a diagram illustrating an example of the event data. The event data illustrated in FIG. 5 may include items such as the date and time, cultivation ID, attribute, and value. The date and time indicates the date and time when the measurement of the environment information made, the observation is made by the worker U, or the work is performed by the worker U. The cultivation ID identifies the cultivation example of one cultivation unit. By including the cultivation ID in the event data, each cultivation example may be identified even when a large number of crops is cultivated simultaneously.

The attribute indicates a type of information included in the event data. The value indicates the attribute value.

The event data illustrated in FIG. 5 include the environment information indicating the temperature of 25.5° C. and the humidity of 70%, and the observation information indicating that disease and pest D is found. The environment information may be received from the sensing unit 20. The observation information may be received from the user terminal 30. In other words, although the event data are illustrated in the form of a table in FIG. 5, the event data do not necessarily need to be received in the units illustrated in FIG. 5. More particularly, the environment information and the observation information may be received separately.

Next, the state updating unit 113 may extract from the state updating rule storage unit 116 the state updating rule related to the crop U, having the condition part matching the event data or the state data (step S102).

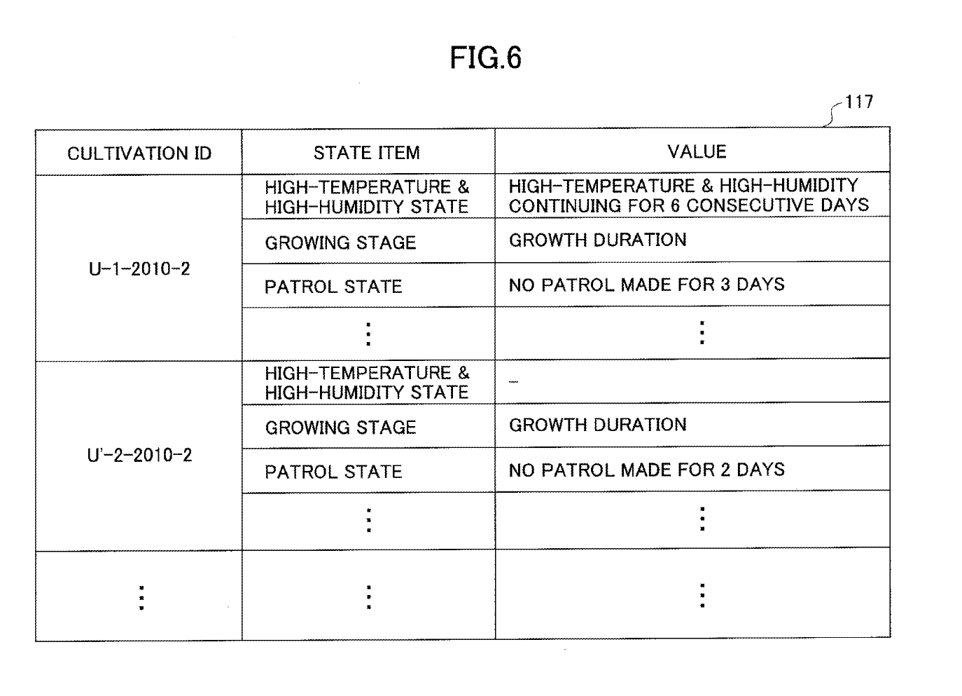

FIG. 6 is a diagram illustrating an example of a configuration of the state data storage unit. In FIG. 6, the state data storage unit 117 may store the state item and the value for each cultivation ID (for each cropping). The state item may indicate an item related to the environment state or the crop state. As illustrated in FIG. 6, a plurality of state items are managed for each cropping. The value indicates the state item value.

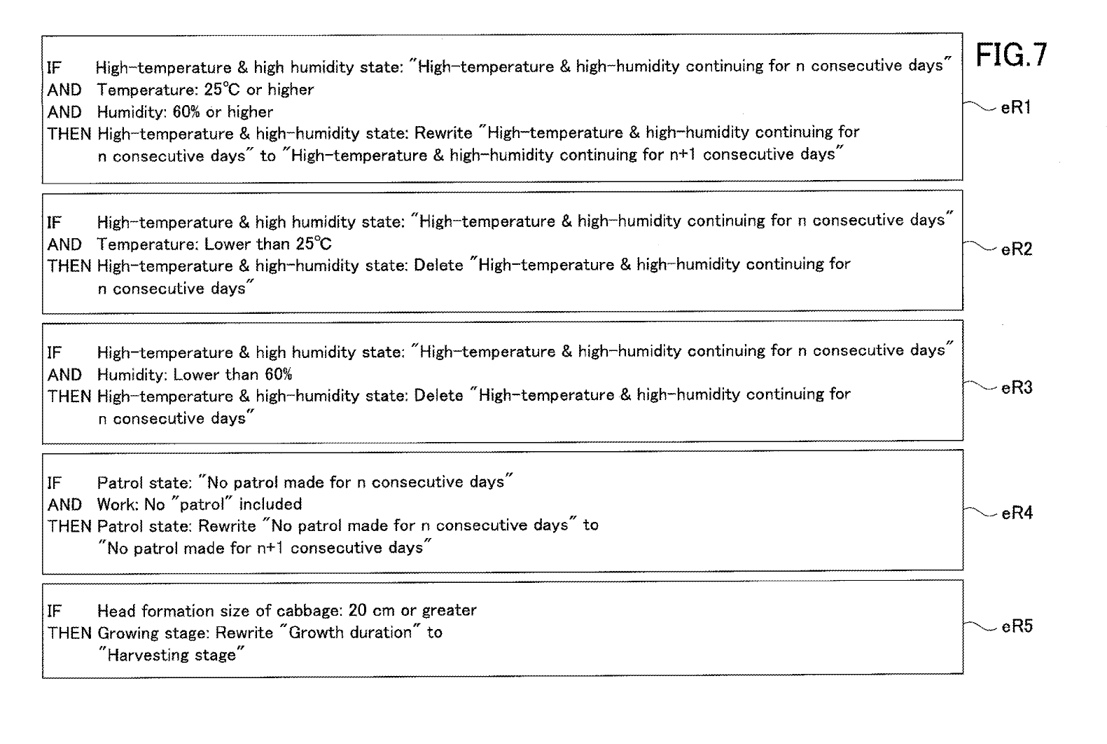

FIG. 7 is a diagram illustrating an example of the state updating rules. FIG. 7 illustrates five state updating rules eR1 through eR5. Each state updating rule includes an IF statement (condition part) and a THEN statement (consequence part). The IF statement may specify a logical product or a logical sum of a plurality of conditions by an AND or an OR.

An example will be described for a case in which cultivation ID of the cultivation “u” for the user is “U-1-2010-2”. When the event data illustrated in FIG. 5, the state data (hereinafter also referred to as “target state data”) related to the cultivation ID “U-1-2010-2”, and the IF statement in the state updating rules eR1 through eR5 are collated, the state updating rule eR1 and the state updating rule eR4 may be extracted.

In other words, in the IF statement of the state updating rule eR1, the condition “High-temperature & high-humidity continuing for n consecutive days” is set with respect to the high-temperature and high-humidity state, the condition “25° C. or higher” is set for the temperature, and the condition “60% or higher” is set for the humidity. In the target state data (FIG. 6), the value of the high-temperature and high-humidity state is “high-temperature & high-humidity continuing for 6 consecutive days”. In addition, in the event data (FIG. 5), the temperature is 25.5° C. (that is, 25° C. or higher), and the humidity is 70% (that is, 60% or higher). Accordingly, the state updating rule eR1 may be extracted.

On the other hand, in the IF statement of the state updating rule eR4, the condition “No patrol made for n consecutive days” is set with respect to the patrol state, and the condition “No “patrol” included” is set with respect to the work. In the target state data (FIG. 6), the value of the patrol state is “No patrol made for 3 days”. In addition, in the event data (FIG. 5), there is no data having “work” as the attribute. Accordingly, the state updating rule eR4 may be extracted.

Next, the state updating unit 113 may update the target state data based on the THEN statements (consequence parts) of the state updating rules eR1 and eR4 that are extracted (step S103). In the THEN statement of the state updating rule eR1, rewriting “High-temperature & high-humidity continuing for n consecutive days” to “High-temperature & high-humidity continuing for n+1 consecutive days” is defined with respect to the high-temperature and high-humidity state. Hence, the state updating unit 113 may update the value of the high-temperature and high-humidity state of the target state data to “High-temperature & high-humidity continuing for 7 consecutive days”. In addition, in the THEN statement of the state updating rule eR4, rewriting “No patrol made for n days” to “No patrol made for n+1 days” is defined with respect to the patrol state. Hence, the state updating unit 113 may update the value of the patrol state of the target state data to “No patrol made for 4 days”.

Next, the work rule extracting unit 114 may extract from the work rule storage unit 118 the work rule having the condition part matching the event data or the target state data (step S104).

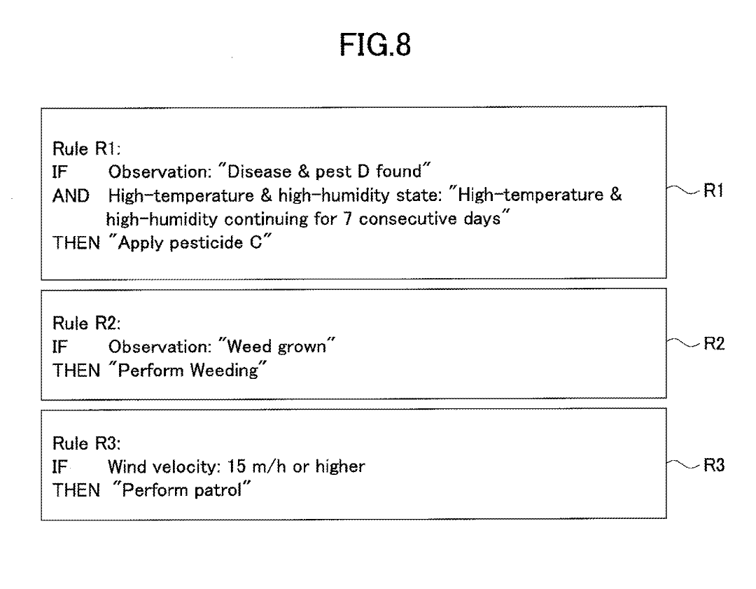

FIG. 8 is a diagram illustrating examples of the work rules. FIG. 8 illustrates three work rules R1 through R3. Each work rule may include an IF statement (condition part) and a THEN statement (consequence part). The IF statement may specify a logical product or a logical sum of a plurality of conditions by an AND or an OR.

In the event data (FIG. 5), the observation value is “disease & pest D found”. In addition, in the target state data after the updating, the value of the high-temperature and high-humidity state is “High-temperature & high-humidity continuing for 7 consecutive days”. Accordingly, in this example, the work rule R1 may be extracted, because the IF statement in the work rule R1 defines the condition “disease & pest D found” with respect to the observation and defines the condition “High-temperature & high-humidity continuing for 7 consecutive days” with respect to the high-temperature and high-humidity state.

Next, the work rule adoption judging unit 115 may judge whether a predetermined amount or more of the work rule adoption log is accumulated with respect to the cultivation “u” (step S105). For example, the work rule adoption judging unit 115 may judge whether the work rule adoption log is recorded in the work rule adoption log storage unit 120 for a predetermined number (for example, four) of work rules, with respect to the cultivation “u”.

When the predetermined amount or more of the work rule adoption log is accumulated (YES in step S105), the work rule adoption judging unit 115 may refer to the work rule adoption log storage unit 120 and specify other cultivation examples (cultivation examples of other workers) similar to or matching the adoption pattern of the work rule adoption for the cultivation “u” (step S106). The cultivation example similar to or matching the adoption pattern of the work rule adoption for the cultivation “u” may be specified as described above in conjunction with FIG. 3.

On the other hand, when the predetermined amount or more of the work rule adoption log is not accumulated (NO in step S105), step S106 is not executed, because comparing similarities of the adoption pattern of the work rule adoption has less significance when the predetermined amount or more of the work rule adoption log is not accumulated.

After step S106 or when the judgement result in step S105 is NO, the work rule adoption judging unit 115 may refer to the cultivation attribute storage unit 119 and specify another cultivation example of a farm located in a region matching that of the cultivation “u” (step S107). In the case in which step S106 is executed, the other cultivation example of the farm located in the region matching that of the cultivation “u” may be specified from the other cultivation examples specified in step S106. On the other hand, when the judgement result in step S105 is NO, or when the other cultivation example with the similar adoption pattern is not found in step S106, the other cultivation example of the farm located in the region matching that of the cultivation “u” may be specified from all of the other cultivation examples. Further, in the case in which a single other cultivation example is specified in step S106, step S107 may be omitted.

Next, the work rule adoption judging unit 115 may judge whether to adopt the work rule R1, based on a judgement result on whether the work rule R1 is adopted in the other cultivation example that is specified (step S108). The judgement result on whether the work rule R1 is adopted in the other cultivation example that is specified may be acquired from the work rule adoption log storage unit 120 related to the crop U. In the case in which the work rule R1 is adopted in the other cultivation example that is specified, the work rule adoption judging unit 115 may adopt the work rule R1. On the other hand, when the work rule R1 is not adopted in the other cultivation example that is specified, the work rule adoption judging unit 115 does not adopt the work rule R1. In the case in which a plurality of other cultivation examples are specified, the work rule adoption judging unit 115 may judge whether to adopt the work rule R1 based on a decision by majority of the judgement results on whether the work rule R1 is adopted in the other cultivation examples that are specified. In this case, the other cultivation examples of the farms located in the region matching that of the cultivation “u” may be weighted. For example, the decision by majority may count two votes with respect to the weighted, other cultivation examples of the farms located in the region matching that of the cultivation “u”.

The THEN statement (consequence part) of the work rule R1 may include a definition “Apply pesticide C” (refer to FIG. 8). Accordingly, the judgement to determine whether to adopt the work rule R1 is equivalent to the judgement to determine whether to apply the pesticide C.

Next, the work rule adoption judging unit 115 may transmit the judgement result to the user terminal 30 via the transmission processing unit 112 (step S109). The user terminal 30 at a transmitting destination may be judged based on the cultivation ID of the cultivation “u”. In other words, an IP (Internet Protocol) address, URL (Uniform Resource Locator), mail address, or the like of the user terminal 30, for example, may be recorded in advance in the auxiliary storage unit 102 in a related manner to the cultivation ID of the cultivation “u”.

An identifier of the work rule R1 and a work instruction (“Apply pesticide C”) indicated by the consequence part of the work rule R1 may be transmitted to the user terminal 30 together with the judgement result. The user may refer to the judgement result, and judge whether to apply the pesticide C. The judgement result may include a basis (for example, information indicating which one of the other cultivation examples is referred to) of the judgement result.

Thereafter, the user may input to the user terminal 30 a work report (that is, information indicating whether the work related to the work instruction is performed) indicating the cultivation ID of the cultivation “u”, the identifier of the work rule R1, and whether the work instruction is adopted.

When the work report is received by the reception processing unit 111 of the farming support apparatus 10 (step S110), the work rule adoption judging part 115 may record the judgement result on whether to adopt the work rule R1 with respect to the cultivation “u” in the work rule adoption log storage unit 120 (step S111).

As described above, according to the first embodiment, whether to adopt (or apply) a work rule extracted with respect to the user may be judged automatically by referring to whether this work rule is adopted in the cultivation examples of the other workers. The cultivation examples of the other workers that are referred to when judging whether to adopt the work rule may be selected based on the similarity of the regions where the farms are located, the similarity of the adoption patterns of the work rule adoption, and the like. The similarity of the regions where the farms are located may also be linked to similarity of weather and soil property. Accordingly, a judgement may be made on whether to adopt the work rule by referring to the other cultivation examples having high similarity in various factors of farming. As a result, the user may obtain effective information with respect to whether to adopt the work rule. In addition, the load on the user to judge whether to adopt the work rule may be reduced.

In other words, in the cultivation of the crop, there are various cultivation policies, values, and the like, even with respect to the same kind of crop. For example, there are differences amongst cost-oriented cultivation placing importance on the cost reduction, quality-oriented cultivation placing importance on the quality, short-term-oriented cultivation placing importance on harvesting within a short term, safety-oriented cultivation placing importance on the safety, and the like. There is a high possibility that the judgement result on whether to adopt the work rule may become different, depending on the differences in such cultivation policies or values. In this embodiment, such background related to the cultivation of the crop is taken into consideration in the judgement result on whether to adopt the work rule, and this judgement result in which the consistency of the cultivation policy or value is secured may be obtained automatically.

Particularly, the comparison with respect to the similarities of past records related to the judgement result on whether to adopt the work rule may be performed in units of one cropping unit. It may be regarded that there is consistency in the value or object at least with respect to one cropping. Accordingly, there is a high possibility of securing the consistency, even in a case in which there is no guarantee that the same person performs the cultivation with the same cultivation policy or the same value.

In the example described above, only one work rule is extracted. However, a plurality of work rules may be extracted simultaneously. In this case, the judgement on whether to adopt the work rule may be performed with respect to each of the simultaneously extracted work rules.

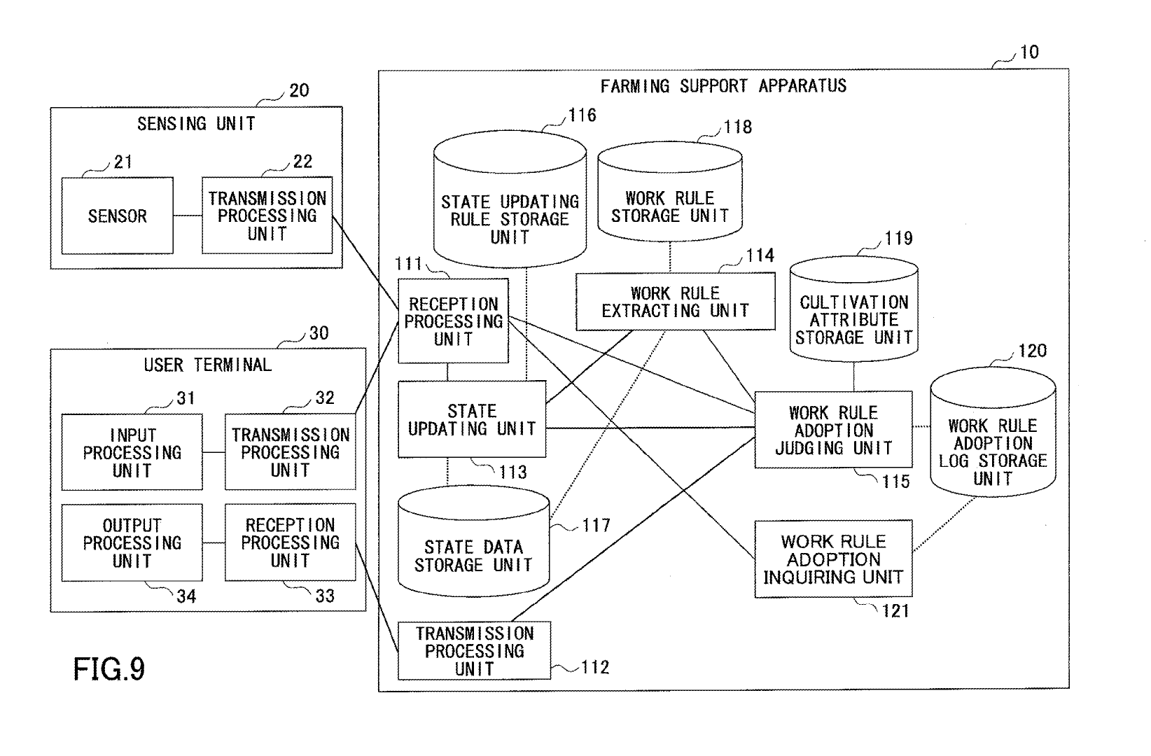

In the first embodiment, the farming support system may have a configuration illustrated in FIG. 9.

FIG. 9 is a diagram illustrating another example of the functional configuration of the farming support system in the first embodiment. In FIG. 9, the farming support apparatus 10 may further include a work rule adoption inquiring unit 121.

The work rule adoption inquiring unit 121 may inquire the user via the user terminal 30 whether the work rule extracted by the work rule extracting unit 114 is to be adopted. In addition, the work rule adoption inquiring unit 121 may record in the work rule adoption log storage unit 120 an inquiry result on whether the work rule is to be adopted, based on a response (judgement result of the user on whether to adopt the work rule) returned from the user terminal 30.

When the functional configuration illustrated in FIG. 9 is employed, the work rule adoption inquiring unit 121 may inquire the user whether the work rule is to be adopted, until a predetermined amount of the work rule adoption log of the user is accumulated.

In other words, when the judgement result in step S105 is NO in FIG. 4, the work rule inquiring unit 121 may transmit to the user terminal 30 the work instruction (for example, “Apply pesticide C”) included in the consequence part of the work rule extracted in step S104. The user may judge whether to adopt the work instruction (that is, the work rule), and input the judgement result to the user terminal 30. The user terminal 30 may return to the work rule inquiring unit 121 a response including the judgement result that is input. The work rule inquiring unit 121 may update the work rule adoption log storage unit 120 based on the judgement result that is returned.

The above described process may be executed in place of the process of steps S107 and S108.

Next, a description will be given of a second embodiment. A description will only be given of features of the second embodiment that differ from those of the first embodiment. Accordingly, unless otherwise indicated, the features not mentioned may be the same as those of the first embodiment.

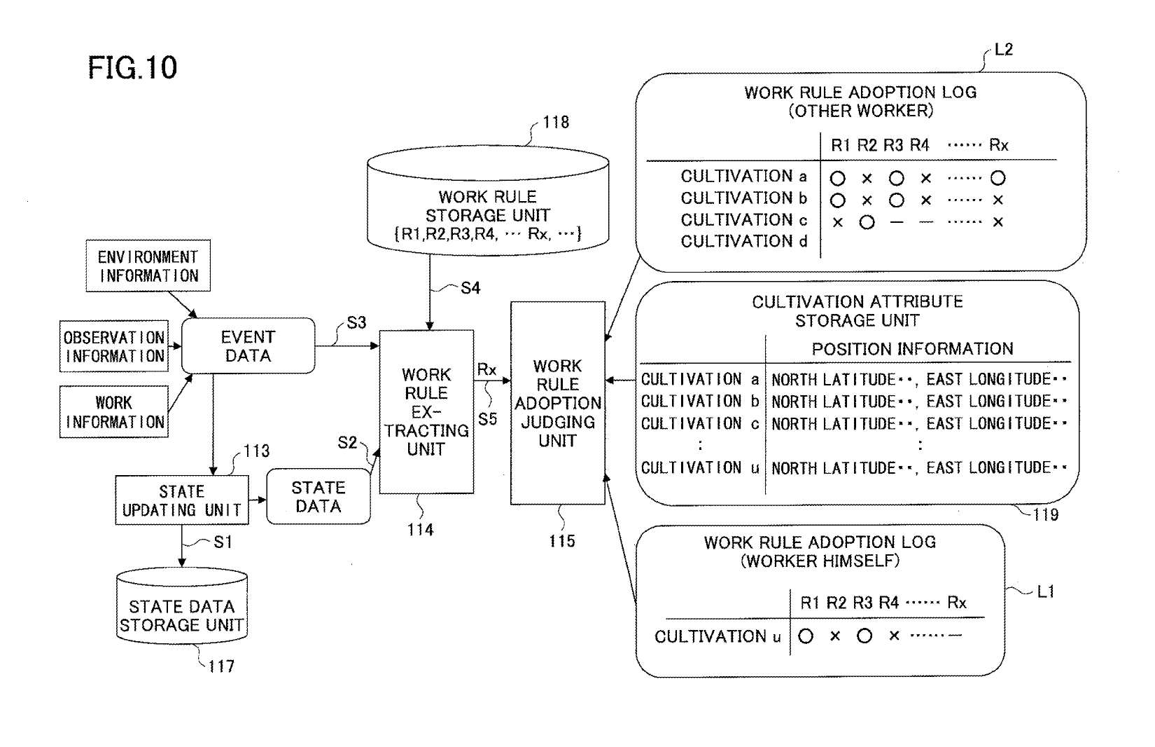

FIG. 10 is a diagram for explaining an example of the process of the farming support apparatus in the second embodiment. In FIG. 10, those parts that are the same as those corresponding parts in FIG. 3 are designated by the same reference numerals, and a description thereof will be omitted.

In the second embodiment, information stored in the cultivation attribute storage unit 119 differs from that of the first embodiment. The cultivation attribute storage unit 119 in the second embodiment may store position information for each farm of each cultivation example related to the crop U. FIG. 10 illustrates an example in which the position information is indicated in north latitude and east longitude of the position where each farm is located. In this embodiment, the position information may be any information that enables computation of a distance between the user (worker U) and each farm related to the cultivation “u”. In other words, the position information may be used to compute the distance between the user and each farm related to the cultivation “u”.

Accordingly, in the second embodiment, the distance between the farms may be used in place of the regions in which the farms are located. In other words, the work rule adoption judging unit 115 may specify the other cultivation examples to be referred to, using the closeness of the distance between the farms as a reference, instead of using the similarity of the adoption patterns of the work rule adoption. More particularly, the other cultivation examples of the farms close to the user may be referred to with priority over cultivation examples of farms that are farther away from the user.

For example, with respect to the work rules R1 through R4 in FIG. 10, the other cultivation examples having the adoption patterns of the work rule adoption similar to that of the cultivation “u” are the cultivations “a” and “b”. In a case in which the distance between the farm of the cultivation “a” and the farm of the cultivation “u” is closer than the distance between the farm of the cultivation “b” and the farm of the cultivation “u”, the work rule adoption judging unit 115 may judge to “adopt” the work rule Rx, based on the judgement result to adopt the work rule Rx of the cultivation “a”. The cultivation attribute storage unit 119 may store, in addition to the planar distance (or distance on a two-dimensional map), information related to a difference in elevation, a gradient, or the like. In this case, the closeness of the distance between the farms may be judged by taking into consideration the difference in elevation, the gradient, or the like in addition to the planar distance.

In the second embodiment, the detailed processing procedures of the work rule adoption judging process may be approximately the same as those described above in conjunction with FIG. 4. However, in step S107 of FIG. 4, the other cultivation example that is specified may be that with the shortest distance between the farms.

The closeness of the distance between the farms may be regarded as being more strict that the similarity of the region where the farms are located in the first embodiment. Accordingly, effects similar to those obtainable by the first embodiment may also be obtained in the second embodiment.

Next, a description will be given of a third embodiment. A description will only be given of features of the third embodiment that differ from those of the first embodiment. Accordingly, unless otherwise indicated, the features not mentioned may be the same as those of the first embodiment.

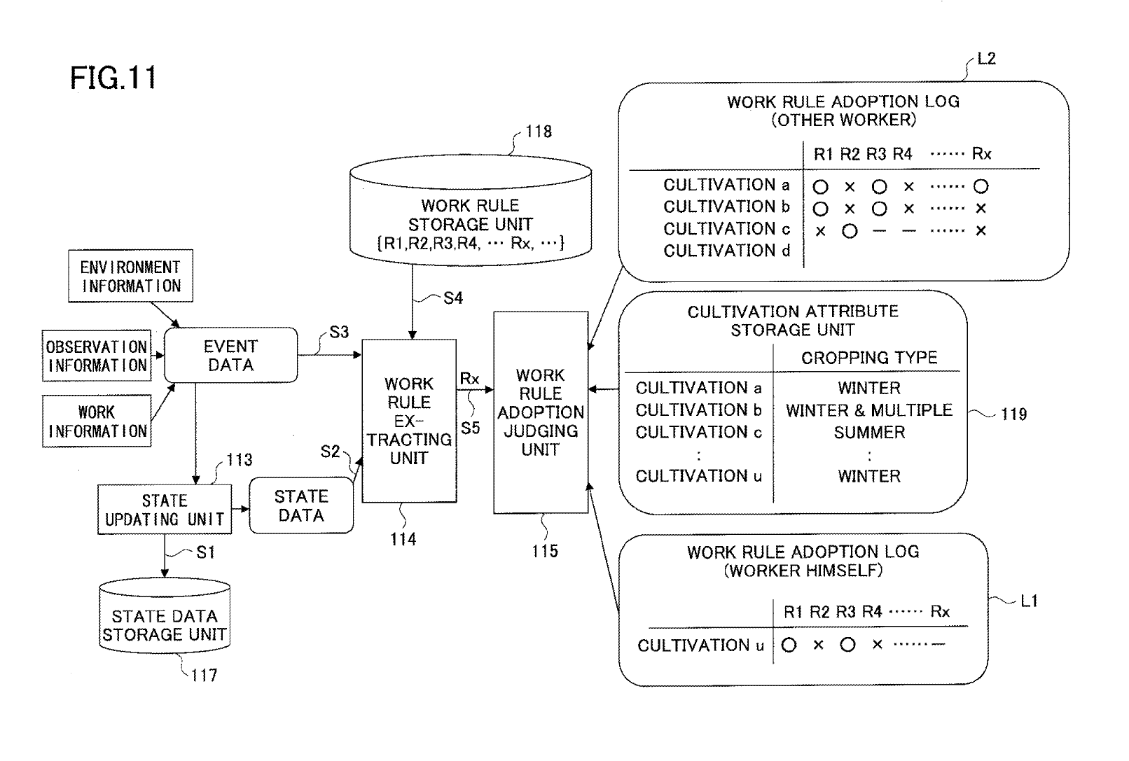

FIG. 11 is a diagram for explaining an example of the process of the farming support apparatus in the third embodiment. In FIG. 11, those parts that are the same as those corresponding parts in FIG. 3 are designated by the same reference numerals, and a description thereof will be omitted.

In the third embodiment, information stored in the cultivation attribute storage unit 119 differs from that of the first embodiment. The cultivation attribute storage unit 119 in the third embodiment may store a crop type of each cultivation example related to the crop U. Accordingly, in the third embodiment, the crop type is used in place of the region where the farm is located. In other words, the work rule adoption judging unit 115 may specify the other cultivation examples to be referred to, using the similarity of the crop types as a reference, instead of using the similarity of the adoption patterns of the work rule adoption. More particularly, the other cultivation examples having a high similarity of the crop types may be referred to with priority over cultivation examples having lower similarity of the crop types.

For example, with respect to the work rules R1 through R4 in FIG. 11, the other cultivation examples having the adoption patterns of the work rule adoption similar to that of the cultivation “u” are the cultivations “a” and “b”. On the other hand, the crop type of the cultivation “a” has a high similarity to the crop type of the cultivation “u”, as compared to the cultivation “b”. Accordingly, the work rule adoption judging unit 115 may judge to “adopt” the work rule Rx, based on the judgement result to adopt the work rule Rx of the cultivation “a”.

In the third embodiment, the detailed processing procedures of the work rule adoption judging process may be approximately the same as those described above in conjunction with FIG. 4. However, in step S107 of FIG. 4, the other cultivation example that is specified may be that with the highest similarity of the crop type.

I general, even with respect to the sake kind of crop, the work required may be different when the crop type is different. Accordingly, by selecting, based on the similarity of the crop type, the other cultivation examples to be referred to when judging whether to adopt the work rule, it may be possible to increase the possibility of obtaining the judgement result on whether to adopt the work rule, more in line with the various factors of the farming.

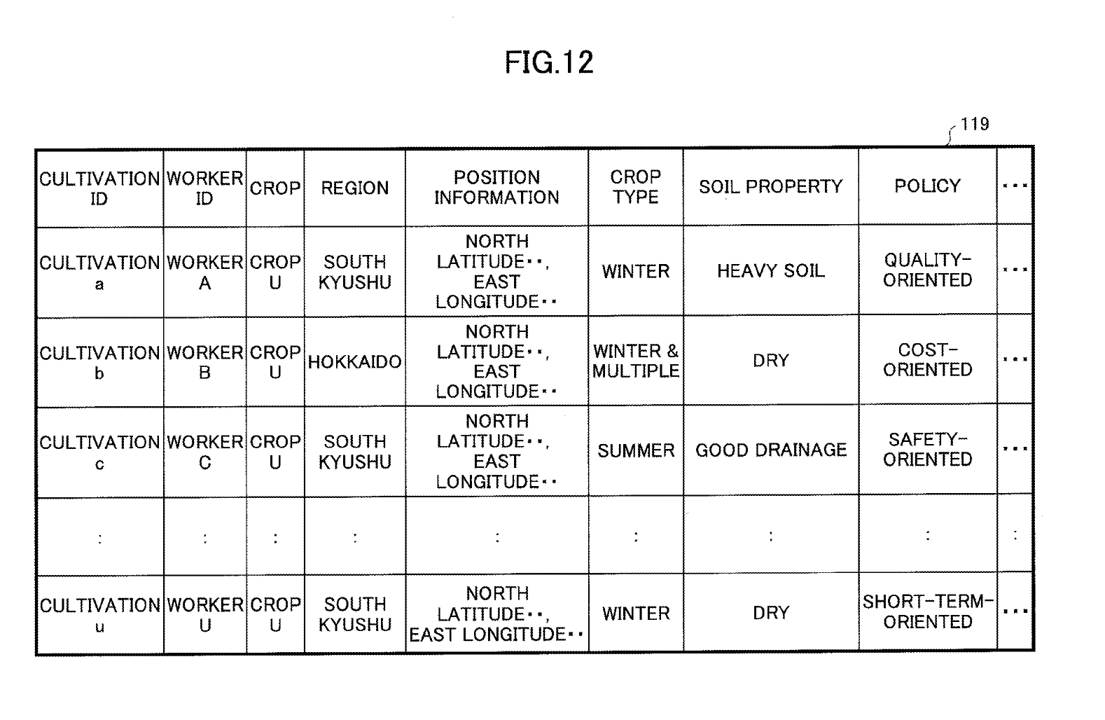

The first, second, and third embodiments described above may be appropriately combined. In other words, step S107 in FIG. 4 may specify the other cultivation example based on the similarity of the regions where the farms are located, the closeness of the distance between the farms, and the similarity of the crop types. Further, other parameters that may affect the farming may also be taken into consideration when specifying the other cultivation example. In this case, the cultivation attribute storage unit 119 may store information illustrated in FIG. 12, for example.

FIG. 12 is a diagram illustrating an example of a configuration of the cultivation attribute storage unit. In FIG. 12, the cultivation attribute storage unit 119 may store the worker ID, crop, region, position information, crop type, soil property, and policy, with respect to each cultivation ID.

The worker ID is the identifier of the worker of the cultivation example related to the cultivation ID. The crop is the kind of crop that is the cultivation target. The region, the position information, and the crop type are the parameters described above in conjunction with the first through third embodiments. The soil property is the property of the soil of the farm. For example, the value of the soil property may indicate heavy soil, dry, good drainage, or the like. The policy is a parameter indicating the policy based on which the cultivation is performed. For example, the policy may distinguish amongst policies that are quality-oriented, cost-oriented, safety-oriented, short-term-oriented, and the like. In FIG. 12, the values of the cultivation ID are indicated as “a”, “b”, “c”, . . . , and “u” for the sake of convenience, and are illustrated in abstraction with respect to the cultivation IDs illustrated in FIG. 5 or FIG. 6.

By using the cultivation attribute storage unit 119 illustrated in FIG. 12, a plurality of parameters may be combined to specify the other cultivation example to be referred to. In this case, points may be assigned to the similarity of the regions where the farms are located, the closeness of the distance between the farms, the similarity of the crop types, the similarity the soil properties, the similarity of the policies, and the like, and the other cultivation example having a highest total number of points may be selected as the target to be referred to.

Next, a description will be given of a fourth embodiment. A description will only be given of features of the fourth embodiment that differ from those of the first embodiment. Accordingly, unless otherwise indicated, the features not mentioned may be the same as those of the first embodiment.

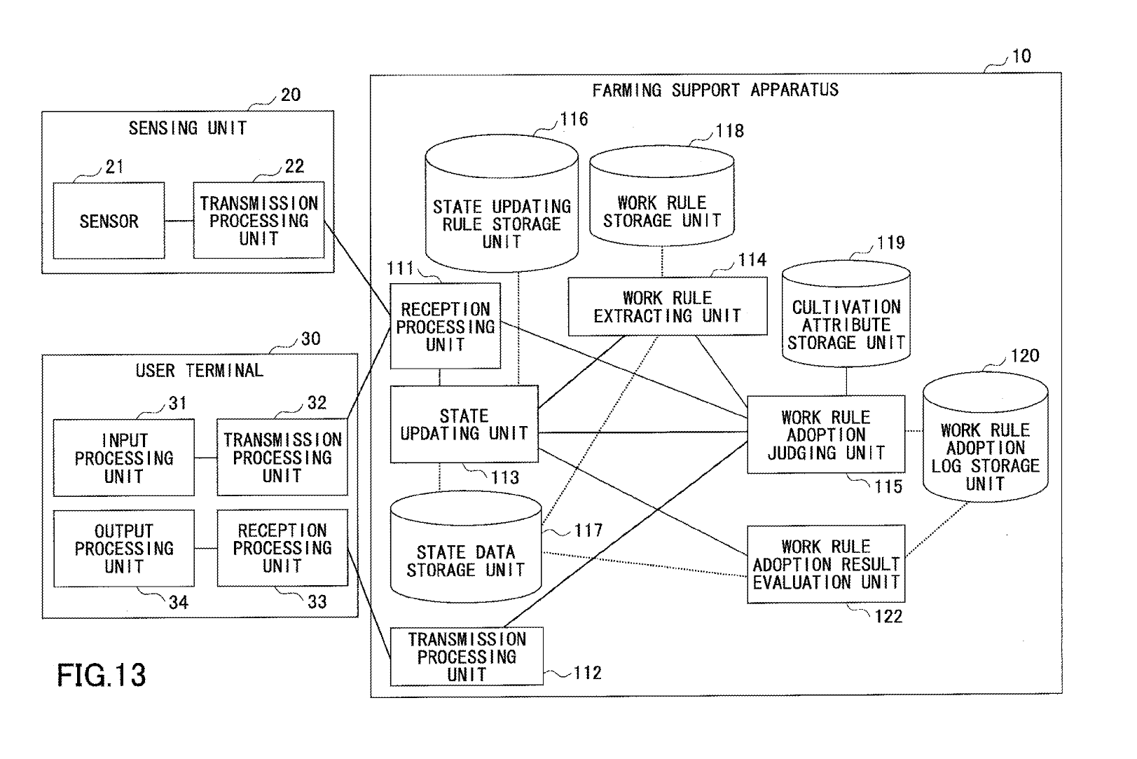

FIG. 13 is a diagram illustrating an example of a functional configuration of the farming support system in the fourth embodiment. In FIG. 13, those parts that are the same as those corresponding parts in FIG. 1 are designated by the same reference numerals, and a description thereof will be omitted.

In FIG. 13, no cultivation attribute storage unit 119 is illustrated. However, this does not imply that the fourth embodiment is exclusive with respect to the embodiments including the cultivation attribute storage unit 119. On the other hand, in FIG. 13, a work rule adoption result evaluation unit 122 is additionally provided. The work rule adoption result evaluation unit 122 may automatically evaluate the validity of the judgement result of the worker on whether to adopt the work rule, based on the environment information or the observation information. The judgement result of the worker on whether to adopt the work rule is the judgement result included in the work report received in step S108 of FIG. 4. In other words, the work rule adoption result evaluation unit 122 may evaluate the validity of the judgement result of the worker on whether to adopt the work rule, which judgement result indicates whether the worker actually performed the work according to the work instruction of the work rule.

A program installed in the farming support apparatus 10 may cause the CPU 104 to execute processes of the work rule adoption result evaluation unit 122.

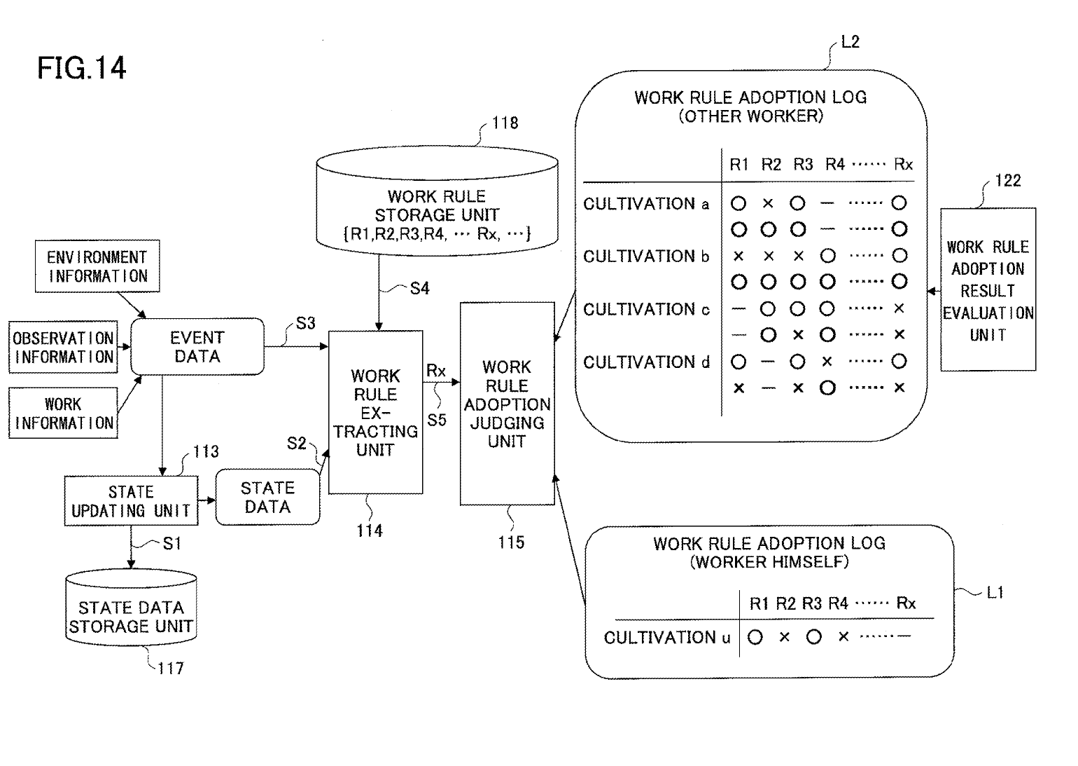

FIG. 14 is a diagram for explaining an example of the process of the farming support apparatus in the fourth embodiment. In FIG. 14, those parts that are the same as those corresponding parts in FIG. 3 are designated by the same reference numerals, and a description thereof will be omitted.

Two rows are allocated for each cultivation example in the work rule adoption log L2 illustrated in FIG. 14. The upper row of the two rows indicates the work rule adoption result. The lower row of the two rows indicates the evaluation result on the validity of the work rule adoption result. A symbol “o” indicates that the work rule adoption result is valid, and a symbol “x” indicates that the work rule adoption result is invalid. The validity of the work rule adoption result may be judged based on the state of the crop and the like. Actually, the evaluation result on the validity of the work rule adoption result may also be recorded in the work rule adoption log L1 of the user, however, the illustration of the evaluation result is omitted in FIG. 14 for the sake of convenience.

In the fourth embodiment, the work rule adoption judging unit 115 may specify the other cultivation example to be referred to, by taking into consideration the evaluation result of the validity of the work rule adoption result indicated by the adoption pattern of the work rule adoption, in addition to the similarity of the adoption pattern of the work rule adoption. In other words, the other cultivation example in which the good crop state (or growing state) is obtained may be referred to with priority over other cultivation examples.

For example, with respect to the work rules R1 through R4 in FIG. 14, the other cultivation examples having the adoption patterns of the work rule adoption similar to that of the cultivation “u” are the cultivations “a” and “b”. On the other hand, with respect to the work rules R1 through R4, the evaluation result of the validity of the work rule adoption result for the cultivation “a” is high relative to other cultivations. In the evaluation result for the cultivation “a”, the symbol “o” is recorded at three locations, while the symbol “x” is recorded at two locations the symbol “o” is recorded at one location in the evaluation result for the cultivation “d”. Accordingly, the work rule adoption judging unit 115 may judge to “adopt” the work rule Rx, based on the judgement result to adopt the work rule Rx of the cultivation “a”.

In the fourth embodiment, the detailed processing procedures of the work rule adoption judging process may be approximately the same as those described above in conjunction with FIG. 4. However, in step S107 of FIG. 4, the other cultivation example may be specified based on the evaluation result of the validity of the work rule adoption result.

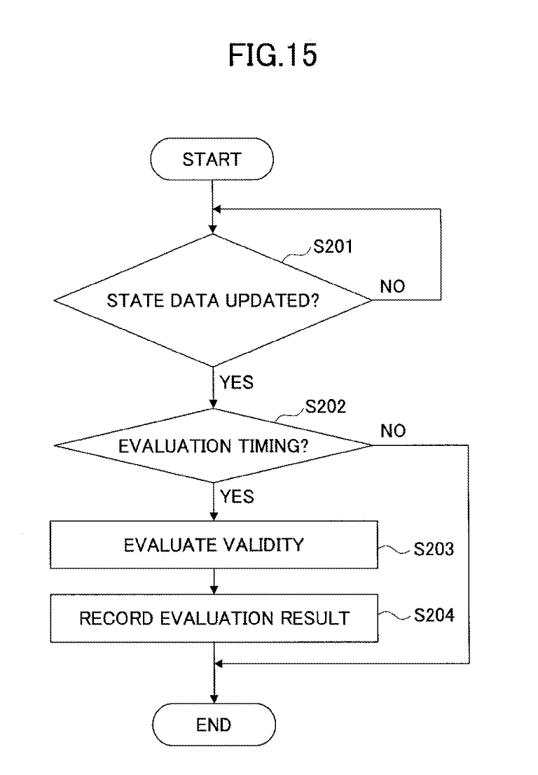

On the other hand, in the fourth embodiment, a validity evaluating process to be described hereinafter is performed on the work rule adoption result, with respect to each cultivation example. FIG. 15 is a flow chart for explaining an example of processing procedures of the validity evaluating process on the work rule adoption result.

The validity evaluating process on the work rule adoption result may be started according to updating of the state data, or target state data (step S201). For example, the validity evaluating process may be started according to step S103 of FIG. 4. In this case, the process of FIG. 15 may be executed in series to the process of FIG. 4, or the process of FIG. 15 may be executed in parallel to the process of FIG. 4.

Next, the work rule adoption result evaluation unit 122 may judge whether it is an evaluation timing to execute the validity evaluating process (step S202). The evaluation timing may be judged based on information indicating the evaluation timing, for example. For example, evaluation timing may be a time when the growing stage changes, a time when the harvesting occurs, a time when a notable change occurs in the crop state, or the like. In addition, the evaluation timing may be a time of the generation or elimination of the disease and pest.

When it is the validity evaluating timing (YES in step S202), the work rule adoption result evaluation unit 122 may evaluate the validity of the work rule adoption result that is recorded in the work rule adoption log storage unit 120 but for which the evaluation result is not recorded (step S203).

The validity evaluation process may be performed based on an evaluation reference that is defined in advance and stored in the auxiliary storage unit 102. The state judged as being valid with respect to the crop may be defined in the evaluation reference, for each growing stage, for example. In addition, the state judged as being valid may be defined as the evaluation reference, in the relationship with respect to the adopted work rule.

For example, suppose that the received event data indicates that the “disease and pest are controlled”. Further, suppose that the state updating rule “IF disease and pest are controlled THEN recover to normal growing state” is applied, and the value of the attribute item in a part of the state data is updated to “recover to normal growing state”. In this case, when the evaluation reference is “after judging whether to adopt the work rule R1, recover to normal growing state”, the work rule adoption result evaluation unit 122 may evaluate that the adoption result to adopt the work rule R1 is valid. The evaluation value indicating the evaluation result may be broken down into more than two stages (“o” or “x”), such as five stages, for example. When breaking down the evaluation value indicating the evaluation result into more than two stages, the evaluation reference may define the evaluation values to be assigned to each growing state and the like.

Next, the work rule adoption result evaluation unit 122 may record the evaluation result (that is, the evaluation value) in the work rule adoption log storage unit 120, with respect to the work rule related to the evaluation result of the cultivation example related to the evaluation result (step S204).

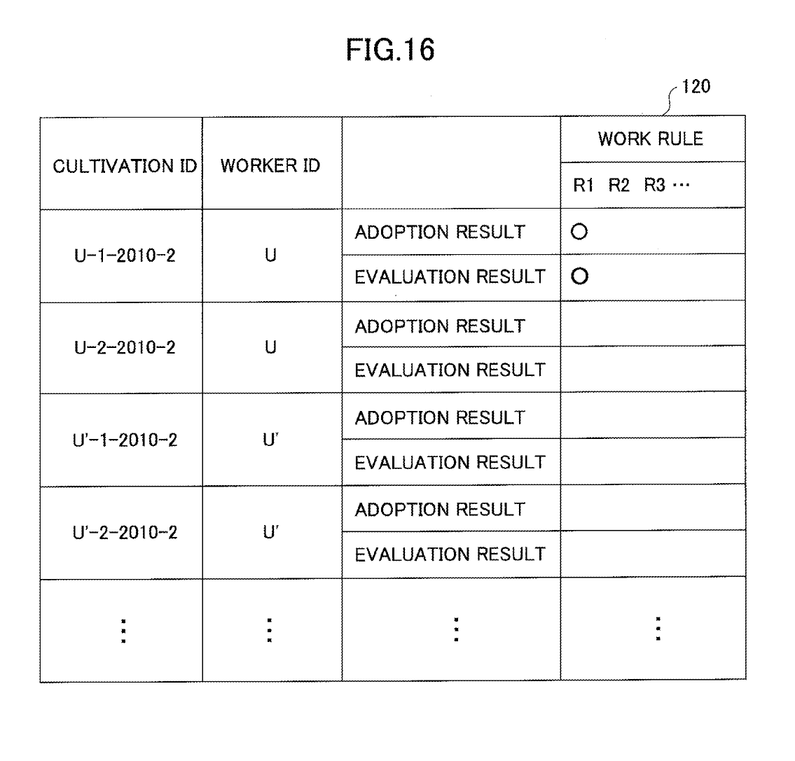

FIG. 16 is a diagram illustrating an example of a configuration of the work rule adoption log storage unit in the fourth embodiment. The example of the configuration of the work rule adoption log storage unit 120 illustrated in FIG. 16 corresponds to a more detailed configuration of the work rule adoption logs L1 and L2 whose illustration is simplified in FIG. 14.

As illustrated in FIG. 16, the work rule adoption log storage unit 120 may record the work rule adoption result and the evaluation result on the validity thereof, with respect to each cultivation ID and each worker ID. FIG. 16 illustrates an example in which the evaluation result “o” is recorded with respect to the work rule R1. The item of the worker ID may be omitted in the work rule adoption log storage unit 120 in a case in which the relation of the cultivation ID and the worker ID is managed separately from the work rule adoption log storage unit 120. In addition, the work rule adoption log storage unit 120 in each of the first through third embodiments may omit the column of the evaluation result for each work rule recorded in the configuration illustrated in FIG. 16.

When a plurality of work rules exist for which the evaluation result is not recorded, the same evaluation result may be recorded with respect to the plurality of work rules. Particularly in a case in which the validity of the work rule adoption result is evaluated according to the updating of the growing stage, there is a high possibility that the evaluation result is not recorded with respect to the plurality of work rules. In this case, the same evaluation result “o” or “x” may be recorded with respect to the plurality of work rules in one evaluation process.

The cultivation example to be the recording target of the evaluation result may be judged based on the cultivation ID and the like included in the event data. Alternatively, the cultivation ID and the like may be transferred to the farming support apparatus 10 when establishing a session before the event data is transmitted from the user terminal 30.

The evaluation of the work rule adoption result does not necessarily need to be performed automatically by the work rule adoption result evaluation unit 122. For example, the evaluation value may be input based on user's perception.

As described above, according to the fourth embodiment, the other cultivation example for which the evaluation on the validity of the work rule adoption result is high relative to other cultivation examples may be referred to when judging whether to adopt the work rule. Accordingly, when other cultivation examples having a similar work rule adoption pattern failed cultivating the crop, the possibility of avoiding a repetition of a similar failure may be increased.

The fourth embodiment may also use the cultivation attribute storage unit 119. For example, the other cultivation example to be referred to may be narrowed down from the other cultivation examples for which the evaluation on the validity of the work rule adoption result is relatively high, based on the similarity of the cultivation attribute.

Next, a description will be given of a fifth embodiment. A description will only be given of features of the fifth embodiment that differ from those of the first embodiment. Accordingly, unless otherwise indicated, the features not mentioned may be the same as those of the first embodiment.

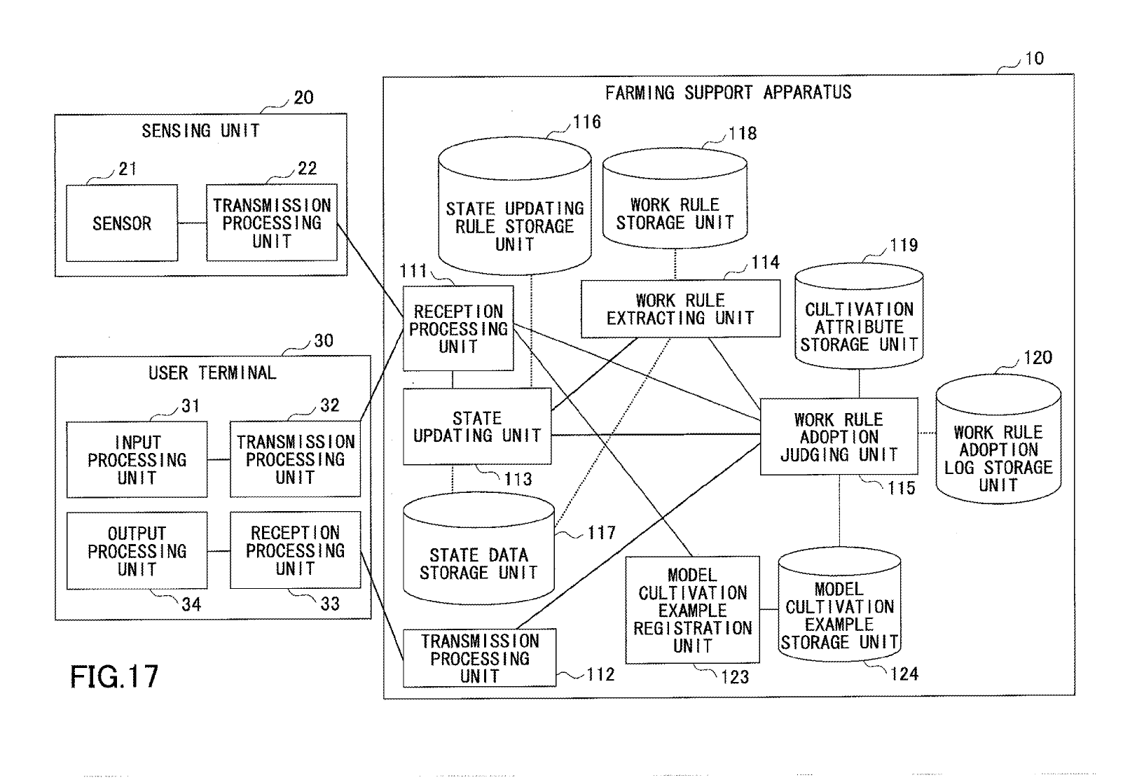

FIG. 17 is a diagram illustrating an example of a functional configuration of the farming support system in the fifth embodiment. In FIG. 17, those parts that are the same as those corresponding parts in FIG. 1 are designated by the same reference numerals, and a description thereof will be omitted.

In FIG. 17, the farming support apparatus 10 additionally includes a model cultivation example registration unit 123 and a mode cultivation example storage unit 124. The model cultivation example storage unit 124 may store the cultivation ID of the other cultivation example (hereinafter also referred to as “model cultivation example”) to be used as a model (or reference) for the judgement on whether to adopt the work rule, in relation to the cultivation ID of the cultivation “u”. The model cultivation example registration unit 123 may record a model candidate of the cultivation example (hereinafter also referred to as “model candidate cultivation example”), and the cultivation example with the work rule adoption pattern similar to that of the model candidate cultivation example, in the model cultivation example storage unit 124, as the model cultivation example, according to the model candidate cultivation example specified from the user terminal 30. A program installed in the farming support apparatus 10 may cause the CPU 104 to execute processes of the model cultivation example registration unit 123. In addition, the model cultivation example storage unit 124 may be formed by the auxiliary storage unit 102 or a storage unit (not illustrated) that is connected to the farming support apparatus 10 via the network.

In the fifth embodiment, the model cultivation example is registered in advance. The validity of the work rule adoption result of the model cultivation example may be referred to when judging whether to adopt the work rule.

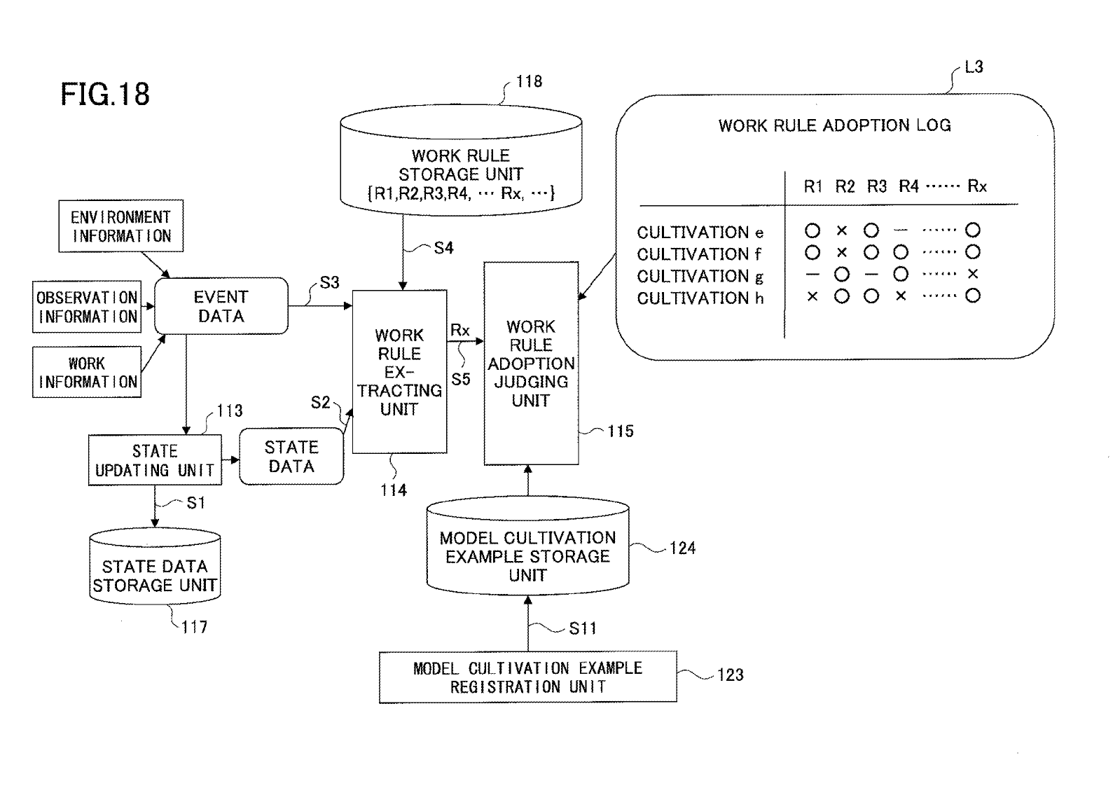

FIG. 18 is a diagram for explaining an example of the process of the farming support apparatus in the fifth embodiment. In FIG. 18, those parts that are the same as those corresponding parts in FIG. 3 are designated by the same reference numerals, and a description thereof will be omitted.

In the fifth embodiment, prior to step S1, the model cultivation example registration unit 123 registers the cultivation ID of the model cultivation example in relation to the cultivation ID of the cultivation “u” in the model cultivation example storage unit 124 (step S11). A plurality of cultivation IDs related to a plurality of cultivation examples may be registered as the model cultivation examples.

The work rule adoption judging unit 115 may judge whether to adopt the work rule Rx, based on the work rule adoption log in a work rule adoption log L3, related to the cultivation ID recorded in the model cultivation example storage unit 124. For example, in a case in which a cultivation example “e” and a cultivation example “f” are specified as the model cultivation examples in the work rule adoption log L3 illustrated in FIG. 18, the work rule adoption judging unit 115 may judge to “adopt” the work rule Rx, based on the work rule adoption result to adopt the work rule Rx in the cultivation examples “e” and “f”.

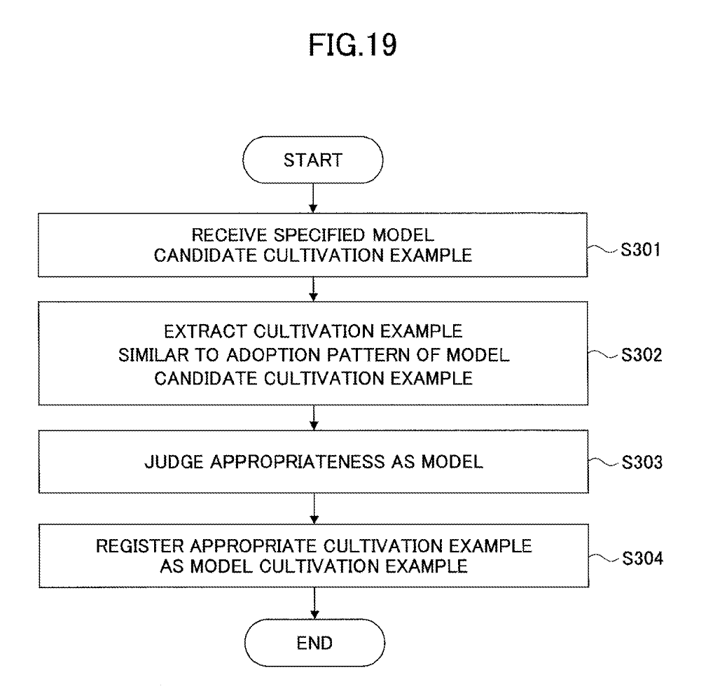

A detailed description will be given of processing procedures of the farming support apparatus 10 in the fifth embodiment. FIG. 19 is a flow chart for explaining an example of the processing procedures of a model cultivating example registration process.

In step S301, the reception processing unit 111 may receive the cultivation ID of the model candidate cultivation example from the user terminal 30. For example, the cultivation ID of the model candidate cultivation example may be related to the cultivation example that is selected by the user on the screen of the display from a list of past cultivation examples displayed at the user terminal 30.

Next, the model cultivation example registration unit 123 may extract from the work rule adoption log storage unit 120 the cultivation example having the work rule adoption pattern similar to that of the model candidate cultivation example (step S302). More particularly, the model cultivation example registration unit 123 may acquire from the work rule adoption log storage unit 120 the work rule adoption pattern of the cultivation example (that is, the model candidate cultivation example) related to the cultivation ID received in step S301. The model cultivation example registration unit 123 may acquire from the work rule adoption log storage unit 120 the cultivation ID of the cultivation example (hereinafter also referred to as “similar cultivation example”) related to the work rule adoption pattern similar to the acquired work rule adoption pattern. The degree of matching (or similarity) is greater than or equal to a predetermined value for the judgement results of the work rule adoption when the work rule adoption patterns are similar.

Next, the model cultivation example registration unit 123 may judge the validity of the model cultivation example for the model candidate cultivation example and the similar cultivation example (step S303). The conditions for judging the validity may be appropriately determined. For example, the validity may be judged using the cultivation attribute storage unit 119. In other words, the validity may be judged based on the similarity of the cultivation attributes (similarity of region in which the farms are located, closeness of the distance between the farms, similarity of the crop types, similarity of the soil properties, similarity of the cultivation policies, or the like) between the cultivation “u” and the other cultivation examples related to the model candidate cultivation example or the similar cultivation example. The validity may be judged based on the similarity of one of the parameters of the cultivation attribute, or may be judged based on a combination of a plurality of parameters of the cultivation attribute. For example, the validity of the model cultivation example for the model candidate cultivation example and the similar cultivation example may be confirmed when a match is found for the region in which the farms are located, the crop types, the soil properties, and the cultivation policies. The validity of the model cultivation example for the model candidate cultivation example and the similar cultivation example may be confirmed when the distance between the farms is less than or equal to a predetermined value. Alternatively, points may be assigned to the similarity of the regions where the farms are located, the closeness of the distance between the farms, the similarity of the crop types, the similarity the soil properties, the similarity of the policies, and the like, and the validity of the model cultivation example for the model candidate cultivation example and the similar cultivation example may be confirmed when the total number of points is greater than or equal to a predetermined value.

Next, the model cultivation example registration unit 123 may register (or record) the cultivation ID of the cultivation example (the model candidate cultivation example or the similar cultivation example) that is judged to be valid, in the model cultivation example storage unit 124, in relation to the cultivation ID of the cultivation “u” (step S304). The cultivation ID of the cultivation example (model candidate cultivation example) selected by the user may be registered, as it is (without judging the validity), in the model cultivation example storage unit 124.

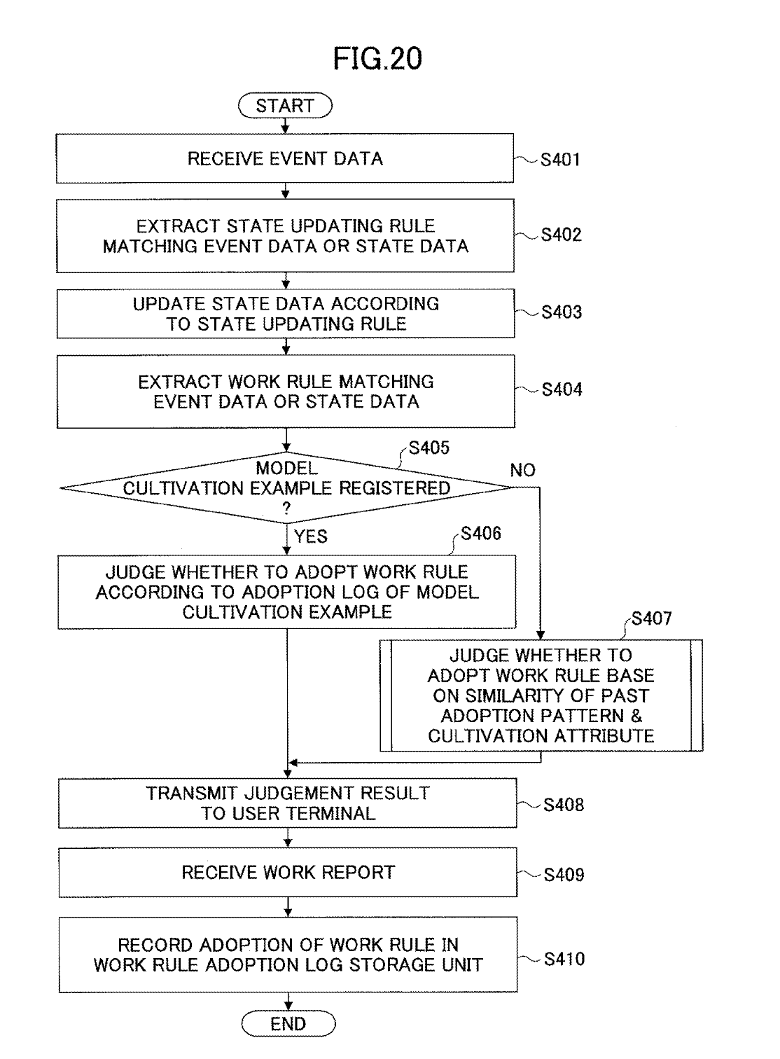

FIG. 20 is a flow chart for explaining an example of processing procedures of the work rule adoption judging process of the farming support apparatus in the fifth embodiment.

Steps S401 through S404 illustrated in FIG. 20 may be the same as steps S101 through S104 illustrated in FIG. 4.

In step S405, the work rule adoption judging unit 115 may judge whether the cultivation ID of the model cultivation example is recorded in the model cultivation example storage unit 124 in relation to the cultivation “u”. When the cultivation ID of the model cultivation example is recorded (YES in step S405), the work rule adoption judging unit 115 may judge whether to adopt the work rule extracted in step S404, based on the work rule adoption log related to the cultivation ID of the model cultivation example (step S406). In other words, when the work rule adoption result in the work rule adoption log is “adopt” (indicated by the symbol “o”) with respect to work rule extracted in step S404, the work rule adoption judging unit 115 may judge to adopt the work rule. On the other hand, when the work rule adoption result in the work rule adoption log is “not adopted” (indicated by the symbol “x”) with respect to work rule extracted in step S404, the work rule adoption judging unit 115 may judge not to adopt the work rule. In a case in which a plurality of work rule adoption logs exist (that is, a plurality of model cultivation examples exist), the whether to adopt the work rule may be judged based on a decision by majority of the work rule adoption logs.

On the other hand, in a case in which the cultivation ID of the model cultivation example is not recorded in the model cultivation example storage unit 124 in relation to the cultivation “u” (NO in step S405), the work rule adoption judging unit 115 may judge whether to adopt the work rule according to processing procedures similar to those of steps S105 through S108 illustrated in FIG. 4 (step S407).

Steps S408 through S410 illustrated in FIG. 20 may be the same as steps S109 through S111 illustrated in FIG. 4.

As described above, according to the fifth embodiment, the cultivation example to be referred to when judging whether to adopt the work rule may be selected based on user's decision. Hence, when judging whether to adopt the work rule, it may be possible to increase the possibility of obtaining the judgement result on whether to adopt the work rule, more in line with the cultivation polity, value, or the like of the user. In addition, the cultivation example selected by the user may be used as a model when judged as being valid as the model. For this reason, it may be possible to avoid a situation where a reference is made to the cultivation example that differs notably when compared to the environment and the like of the user's farm.

In each of the embodiments described above, the work rule may be an example of restriction information. The work rule storage unit 118 may be an example of a restriction information storage unit. The work rule adoption log storage unit 120 may be an example of an adoption log storage unit. The cultivation attribute storage unit 119 may be an example of an attribute storage unit. The reception processing unit 111 may be an example of an accepting unit. The work rule extracting unit 114 may be an example of an extracting unit. The work rule adoption judging unit 115 may be an example of a judging unit.

Although the embodiments are numbered with, for example, “first,” “second,” “third,” “fourth,” or “fifth,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A farming support method comprising:
accepting, by a processor, input of information indicating a state of a crop or information indicating a state of an environment;
extracting, by the processor, from a restriction information storage unit that stores restriction information including a condition related to the state of the crop or the state of the environment and a work instruction for a case in which the condition is satisfied, the restriction information having the condition matching the information indicating the state of the crop or the information indicating the state of the environment that is input; and
judging, by the processor, using an adoption log storage unit that stores a judgement result on whether to adopt each restriction information for each cultivation example of the crop, whether to adopt the restriction information that is extracted.

2. The farming support method as claimed in claim 1, wherein the judging includes
extracting, based on a similarity of a region where a farm is located, crop type, soil property, or cultivation policy of the crop that are stored in an attribute storage unit with respect to a first cultivation example related to the restriction information that is extracted and other cultivation examples, between the first cultivation example and the other cultivation examples, in order to extract a second cultivation example from the other cultivation examples, and
judging whether to adopt the restriction information based on the judgement result on whether to adopt each restriction information stored in the adoption log storage unit with respect to the second cultivation example.

3. The farming support method as claimed in claim 1, wherein the judging includes
collating, judgement results on whether to adopt the restriction information that are stored in the adoption log storage unit with respect to a first cultivation example related to the restriction information that is extracted and other cultivation examples, between the first cultivation example and the other cultivation examples, in order to extract a second cultivation example having a large number of matches of the judgement results relative to others from the other cultivation examples, and
judging whether to adopt the restriction information based on the judgement result on whether to adopt each restriction information stored in the adoption log storage unit with respect to the second cultivation example.

4. A farming support apparatus comprising:
an accepting unit configured to accept input of information indicating a state of a crop or information indicating a state of an environment;
an extracting unit configured to extract from a restriction information storage unit that stores restriction information including a condition related to the state of the crop or the state of the environment and a work instruction for a case in which the condition is satisfied, the restriction information having the condition matching the information indicating the state of the crop or the information indicating the state of the environment that is input; and
a judging unit configured to judge, using an adoption log storage unit that stores a judgement result on whether to adopt each restriction information for each cultivation example of the crop, whether to adopt the restriction information that is extracted.

5. The farming support apparatus as claimed in claim 4, wherein the judging unit executes a process including
extracting, based on a similarity of a region where a farm is located, crop type, soil property, or cultivation policy of the crop that are stored in an attribute storage unit with respect to a first cultivation example related to the restriction information that is extracted and other cultivation examples, between the first cultivation example and the other cultivation examples, in order to extract a second cultivation example from the other cultivation examples, and
judging whether to adopt the restriction information based on the judgement result on whether to adopt each restriction information stored in the adoption log storage unit with respect to the second cultivation example.

6. The farming support apparatus as claimed in claim 4, wherein the judging unit executes a process including
collating, judgement results on whether to adopt the restriction information that are stored in the adoption log storage unit with respect to a first cultivation example related to the restriction information that is extracted and other cultivation examples, between the first cultivation example and the other cultivation examples, in order to extract a second cultivation example having a large number of matches of the judgement results relative to others from the other cultivation examples, and
judging whether to adopt the restriction information based on the judgement result on whether to adopt each restriction information stored in the adoption log storage unit with respect to the second cultivation example.

7. A non-transitory computer-readable storage medium having stored therein a program for causing a computer to execute a process to support farming, the process comprising:
accepting input of information indicating a state of a crop or information indicating a state of an environment;
extracting from a restriction information storage unit that stores restriction information including a condition related to the state of the crop or the state of the environment and a work instruction for a case in which the condition is satisfied, the restriction information having the condition matching the information indicating the state of the crop or the information indicating the state of the environment that is input; and
judging, using an adoption log storage unit that stores a judgement result on whether to adopt each restriction information for each cultivation example of the crop, whether to adopt the restriction information that is extracted.

8. The non-transitory computer-readable storage medium as claimed in claim 7, wherein the judging includes
extracting, based on a similarity of a region where a farm is located, crop type, soil property, or cultivation policy of the crop that are stored in an attribute storage unit with respect to a first cultivation example related to the restriction information that is extracted and other cultivation examples, between the first cultivation example and the other cultivation examples, in order to extract a second cultivation example from the other cultivation examples, and
judging whether to adopt the restriction information based on the judgement result on whether to adopt each restriction information stored in the adoption log storage unit with respect to the second cultivation example.

9. The non-transitory computer-readable storage medium as claimed in claim 7, wherein the judging includes
collating, judgement results on whether to adopt the restriction information that are stored in the adoption log storage unit with respect to a first cultivation example related to the restriction information that is extracted and other cultivation examples, between the first cultivation example and the other cultivation examples, in order to extract a second cultivation example having a large number of matches of the judgement results relative to others from the other cultivation examples, and
judging whether to adopt the restriction information based on the judgement result on whether to adopt each restriction information stored in the adoption log storage unit with respect to the second cultivation example.
